(19) United States
(12) Patent Application Publication
(10) Pub. No.: US 2018/0287868 A1
(43) Pub. Date: Oct. 4, 2018

(54) CONTROL METHOD AND CONTROL DEVICE

(71) Applicant: FUJITSU LIMITED, Kawasaki-shi (JP)

(72) Inventors: Kazufumi Noto, Kawasaki (JP); Kazuki Teraoka, Ota (JP); Takehisa Onishi, Numazu (JP); Takuju Tatsumi, Yokohama (JP)

(73) Assignee: FUJITSU LIMITED, Kawasaki-shi (JP)

(21) Appl. No.: 15/920,876

(22) Filed: Mar. 14, 2018

(30) Foreign Application Priority Data
Mar. 31, 2017 (JP) 2017-073103

(51) Int. Cl. H04L 12/24; H04L 29/08

(52) U.S. Cl. CPC H04L 41/0806; H04L 67/1095

(57) ABSTRACT

A control device that constructs a system in a cloud includes a memory and a processor coupled to the memory. The processor is configured to acquire first definition information relating to system construction and second definition information relating to software used for the system construction. The processor is configured to construct a first system in a first cloud by using the first definition information and the second definition information accepted by the accepting unit. The processor is configured to transmit the first definition information and the second definition information to another control device that constructs a second system in a second cloud using the first definition information and the second definition information. The second system is the same as the first system.

### CROSS-REFERENCE TO RELATED APPLICATION

This application is based upon and claims the benefit of priority of the prior Japanese Patent Application No. 2017-073103, filed on Mar. 31, 2017, the entire contents of which are incorporated herein by reference.

### FIELD

The present disclosure relates to a control method, a control device, and a non-transitory computer-readable recording medium having stored therein a control program.

### BACKGROUND

In recent years, in cloud, services of offering a platform of hardware, operating system (OS), and so forth for running of application software have been carried out. Such services are called Platform as a Service (PaaS). For example, in the cloud, in response to a request from a business operator that utilizes a service, a virtual system obtained by combining virtual server and virtual pieces of hardware such as firewall and network is constructed.

Examples of related-art documents are Japanese Laid-open Patent Publication No. 2007-183747 and Japanese Laid-open Patent Publication No. 5-100828.

### SUMMARY

According to an aspect of the present invention, provided is a control device that constructs a system in a cloud. The control device including a memory and a processor coupled to the memory. The processor is configured to acquire first definition information relating to system construction and second definition information relating to software used for the system construction. The processor is configured to construct a first system in a first cloud by using the first definition information and the second definition information accepted by the accepting unit. The processor is configured to transmit the first definition information and the second definition information to another control device that constructs a second system in a second cloud using the first definition information and the second definition information. The second system is the same as the first system.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of a configuration of a system according to embodiment 1;

FIG. 2 is a diagram illustrating one example of a configuration of a cloud according to embodiment 1;

FIG. 3 is a diagram illustrating one example of flow of construction of a platform according to embodiment 1;

FIG. 4A is a diagram illustrating one example of an operation screen according to embodiment 1;

FIG. 4B is a diagram illustrating one example of an operation screen according to embodiment 1;

FIG. 5 is a diagram illustrating one example of construction of a system according to embodiment 1;

FIG. 6 is a diagram illustrating one example of an operation screen according to embodiment 1;

FIG. 7 is a diagram for explaining one example of flow of control processing according to embodiment 1; and

FIG. 8 is a diagram illustrating one example of a hardware configuration.

### DESCRIPTION OF EMBODIMENTS

Incidentally, in the cloud, the same system as a system that has been constructed is constructed in a distributed manner in some cases for various reasons such as backup and load balancing, for example. It is conceivable that, in such a case, an image of the system that has been constructed is transferred to the new construction destination and the same system is constructed. However, the image of the system has a large volume and a transfer load is imposed on the network if the image of the system is transferred.

Embodiments of a control program, a control method, and a control device disclosed by the present application will be described in detail below based on the drawings. The disclosed techniques are not limited by the present embodiments. Furthermore, the respective embodiments to be represented below may be combined as appropriate within such a range as not to cause contradiction.

### Embodiment 1

[Explanation of Whole System]

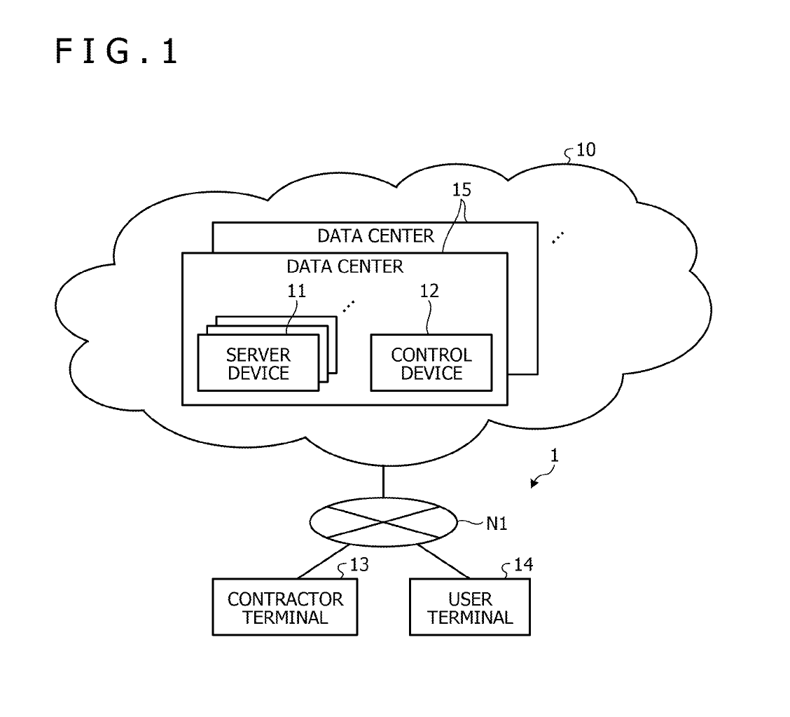

First, the schematic configuration of a system that offers a service based on cloud computing (hereinafter, often represented as “cloud”) will be described. FIG. 1 is a diagram illustrating one example of a configuration of a system according to embodiment 1. A system 1 includes a cloud 10, a contractor terminal 13, and a user terminal 14. In the system 1 in the present embodiment, the cloud 10, the contractor terminal 13, and the user terminal 14 are each coupled mutually communicably through a network N1. As such a network N1, an arbitrary kind of communication network such as the Internet, a local area network (LAN), or a virtual private network (VPN) may be employed irrespective of whether the communication network is a wired network or a wireless network.

The cloud 10 includes plural server devices 11 and a control device 12. The cloud 10 is constructed in such a manner as to be distributed into plural entities. For example, a cloud service operator develops a data center 15 in each of plural regions that are geographically distant, such as different countries or cities. The cloud 10 is constructed by plural data centers 15 developed by the cloud service operator. The plural server devices 11 and the control device 12 are disposed in each of the data centers 15. The data centers 15 individually function as the cloud 10.

The cloud 10 offers computer resources based on a computer network by using various kinds of hardware including the plural server devices 11 and the control device 12 disposed in the respective data centers 15 and software. The cloud 10 in the present embodiment offers a service of offering an operation environment in which application software is run as a platform by using hardware and pieces of software such as OS and middleware. For example, in each data center 15, Infrastructure as a Service (IaaS) serving as a base for constructing and running a computer system of virtual machine, network, and so forth is constructed. The cloud 10 offers a service of PaaS that offers an operation environment in which application software of a customer is run as a platform on the IaaS of each data center 15. For example, the cloud service operator makes a contract with a business operator that desires to use the service offered by the cloud 10. Hereinafter, the business operator that has made a contract with the cloud service operator will be often represented as the “contractor.” In accordance with the contract with the contractor, the cloud 10 constructs a platform in any data center 15 in the cloud 10 and offers a platform to the contractor through the network N1.

The contractor terminal 13 is an information processing device used by a contractor that has made a contract with the cloud service operator. For example, the contractor develops application software runs in the cloud 10 by using the contractor terminal 13 and runs the developed application software on a platform of the cloud 10 to carry out various kinds of businesses such as Web (World Wide Web) services. For example, the contractor is a tenant that runs each business by using the cloud 10. The contractor terminal 13 is an information processing device that belongs to the tenant, for example.

The user terminal 14 is an information processing device used by a general user who uses businesses such as Web services based on application software that runs on a platform of the cloud 10. Hereinafter, the general user who uses businesses such as Web services offered by a tenant by using the cloud 10 will be often represented as the “user.” For example, the user uses the user terminal 14 to access application software that runs on a platform of the cloud 10 and use various kinds of services offered by the application software.

In the example of FIG. 1, one contractor terminal 13 and one user terminal 14 are diagrammatically represented. However, the numbers of contractor terminals 13 and user terminals 14 may be set to arbitrary numbers. Furthermore, plural control devices 12 may exist although one control device 12 is diagrammatically represented in the example of FIG. 1.

The cloud 10 offers the contractor a service of constructing a platform in the cloud 10 and allowing use of this constructed platform. For example, the control device 12 constructs plural platforms in the cloud 10 in response to reception of definition information relating to the construction of the platform from the contractor terminal 13 of each contractor through the network N1.

[Configuration of Cloud]

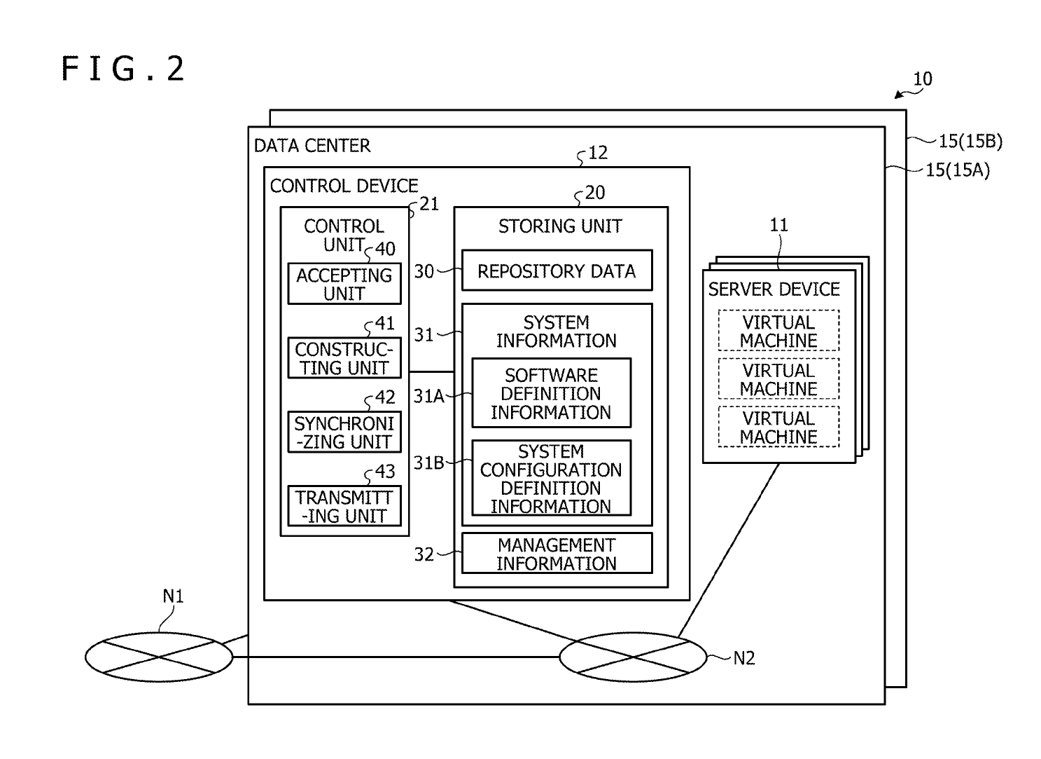

Next, the schematic configuration of the cloud 10 will be described. In the present embodiment, for simplification of explanation, the description will be made by taking as an example the case in which the cloud 10 is implemented by two data centers 15 (15A and 15B). FIG. 2 is a diagram illustrating one example of a configuration of a cloud according to embodiment 1. Although two data centers 15A and 15B are diagrammatically represented in the example of FIG. 2, the number of data centers 15 may be set to an arbitrary number as long as the number is equal to or larger than 2.

The respective data centers 15 are disposed at geographically-distant locations. Suppose that, in the present embodiment, the respective data centers 15 are disposed in different areas such as different cities or countries. For example, the data center 15A is disposed in region A. The data center 15B is disposed in region B. Regions A and B may be countries such as countries A and B. Furthermore, regions A and B may be different cities in the same country, for example.

The functional configurations of the respective data centers 15 are substantially identical. Thus, in FIG. 2, the configuration is illustrated in detail regarding the data center 15A. As illustrated in FIG. 2, each data center 15 includes the plural server devices 11 and the control device 12.

The plural server devices 11 and the control device 12 are coupled by a network N2 provided in the data center 15 and are enabled to communicate. The network N2 is communicably coupled to the external network N1 such as the Internet and is enabled to communicate with other data centers 15, the contractor terminals 13, and the user terminals 14 through the network N1. Although three server devices 11 are diagrammatically represented in the example of FIG. 2, the number of server devices 11 may be set to an arbitrary number. Furthermore, plural control devices 12 may exist although one control device 12 is diagrammatically represented in the example of FIG. 2.

The server devices 11 are physical servers provided in the data center 15 and are server computers, for example. The server device 11 may operate a virtual machine obtained by virtualizing a computer by using a virtualization technique. In the example of FIG. 2, three virtual machines operate on the server device 11. The virtual machines may function as various kinds of servers such as firewall, load balancer, Web server, application (AP) server, and database (DB) server according to embedded middleware.

The control device 12 is also a physical server provided in the data center 15 and is a server computer, for example. The control device 12 controls the server devices 11. The control device 12 may be a virtual machine that operates in any server device 11.

The control device 12 carries out management and operation of services offered by the cloud 10. The control device 12 is allowed to be accessed from the contractor terminal 13 and constructs and offers a platform for running of application software in response to a request from a contractor. For example, the cloud 10 virtualizes network equipment that forms the network N2 and various kinds of hardware resources including the server devices 11 by using a virtualization technique. The control device 12 constructs a platform including a virtual system obtained by combining virtual hardware resources in the cloud 10.

[Configuration of Control Device]

Next, the configuration of the control device 12 will be described. As illustrated in FIG. 2, the control device 12 includes a storing unit 20 and a control unit 21. The control device 12 may include various kinds of functional units possessed by a known computer, functional units such as various kinds of input devices and audio output devices, besides the functional units illustrated in FIG. 2.

The storing unit 20 is implemented by a semiconductor memory element such as a random access memory (RAM) or a flash memory or a storing device such as a hard disk or an optical disk. The storing unit 20 stores OS and various kinds of programs executed in the control unit 21. For example, the storing unit 20 stores a program to execute control processing to be described later. Moreover, the storing unit 20 stores various kinds of data used in the program executed in the control unit 21. For example, the storing unit 20 includes repository data 30, system information 31, and management information 32. The repository data 30, the system information 31, and the management information 32 may be stored in another device such as another server computer or a storage device.

The repository data 30 is data in which data of pieces of software such as OS, middleware, and application software offered as a service of a platform is stored. For example, in the repository data 30, data of various kinds of OS, pieces of middleware such as database management software and server software, and pieces of software such as general-purpose applications is stored.

The system information 31 is data in which various kinds of information relating to systems are stored. For example, in the system information 31, various kinds of definition information used for construction of a system are stored. The system information 31 according to the present embodiment includes software definition information 31A and system configuration definition information 31B.

The software definition information 31A is data in which information relating to software used in a system is stored. For example, in the software definition information 31A, definition information that specifies the number of servers constructed as a system, the OS with which the servers are equipped, middleware, and applications is stored. Furthermore, in the software definition information 31A, programs of pieces of software are stored regarding application software developed by a contractor and software that is not offered by a service of a platform, for example.

The system configuration definition information 31B is data in which information relating to the system configuration is stored. For example, in the system configuration definition information 31B, definition information that specifies the configuration of the network among the servers is stored.

In the system information 31, the software definition information 31A and the system configuration definition information 31B used for construction of a system are managed and stored as a package.

The management information 32 is data in which various kinds of information relating to constructed systems are stored. For example, in the management information 32, information on the construction destination of a system, a package used for the construction of the system, the running state of the system, and so forth is stored.

The control unit 21 is implemented through execution of a program stored in an internal storing device with use of the RAM as a work area by a central processing unit (CPU), a micro processing unit (MPU), or the like, for example. Furthermore, the control unit 21 may be implemented by an integrated circuit such as an application specific integrated circuit (ASIC) or a field programmable gate array (FPGA).

The control unit 21 includes an accepting unit 40, a constructing unit 41, a synchronizing unit 42, and a transmitting unit 43 and implements or carries out functions and operation of the control processing to be described below. The internal configuration of the control unit 21 is not limited to the configuration illustrated in FIG. 2 and may be another configuration as long as the internal configuration is a configuration that executes the control processing to be described later. For example, each processing unit carries out transmission and reception of data with another computer through a communication unit, which is not diagrammatically represented. Furthermore, for example, a configuration may be employed in which each processing unit accepts operation by an administrator through an input unit, which is not diagrammatically represented, and constructs a platform. Moreover, the accepting unit 40, the constructing unit 41, the synchronizing unit 42, and the transmitting unit 43 are one example of an electronic circuit such as a processor or one example of a process carried out by a processor or the like.

The accepting unit 40 accepts various kinds of operation and various kinds of information. For example, the accepting unit 40 controls display of various kinds of operation screens for use of a service of the cloud 10.

When a contract for use of a service of the cloud 10 is made, the contractor is given a contractor identification (ID) and a password and is notified of an address such as a uniform resource locator (URL) address for accessing the control device 12. The contractor accesses the control device 12 by using the contractor terminal 13 when using the service of the cloud 10.

When accepting the access, the accepting unit 40 carries out control to transmit information on various kinds of operation screens to the access source and cause the access source to display the operation screens. For example, in response to access from the contractor terminal 13, the accepting unit 40 causes the contractor terminal 13 to display a login screen and causes the contractor to enter the contractor ID and the password to accept login. When the login succeeds, the accepting unit 40 carries out control to cause the contractor terminal 13 to display various kinds of screens such as operation screens. For example, the accepting unit 40 causes the contractor terminal 13 to display an operation screen to define a system to be constructed as a platform, an operation screen to make an instruction to construct the platform, and an operation screen to carry out setting for the constructed platform.

For example, the accepting unit 40 accepts specifying relating to software, such as the number of servers constructed as a system, the OS with which the servers are equipped, middleware, and applications, from the operation screen. Furthermore, the accepting unit 40 accepts specifying relating to the configuration of the system, such as the configuration of the network among the servers, from the operation screen. The accepting unit 40 stores the specified information relating to the system in the system information 31. For example, the accepting unit 40 stores the information specified regarding software in the software definition information 31A. Furthermore, the accepting unit 40 stores the information specified regarding the configuration of the system in the system configuration definition information 31B. The definition information of the system does not necessarily have to be entered from the operation screen by the user. For example, the accepting unit 40 may accept uploading of the definition information and store the definition information in the system information 31. Moreover, for example, the definition information of a standard system may be stored in the system information 31 in advance.

Furthermore, the accepting unit 40 accepts an instruction to specify a system to be constructed and construct a platform from the operation screen. For example, the accepting unit 40 accepts specifying of a system to be constructed as a platform among plural systems whose definition information has been registered.

The constructing unit 41 constructs a system in the data center 15 as a platform in response to an instruction from the operation screen. For example, the constructing unit 41 reads out the definition information relating to the specified system from the system information 31 and constructs the system based on the read-out definition information. For example, the constructing unit 41 reads out OS, middleware, and application software from the repository data 30 in accordance with the software definition information 31A of the specified system. The constructing unit 41 generates a virtual machine and embeds the OS, middleware, and application software specified in the software definition information 31A to generate the virtual machine having functions according to the specified kind. For example, by changing the middleware embedded in the virtual machine, the constructing unit 41 generates the virtual machine having various kinds of functions, such as firewall, load balancer, Web server, AP server, and DB server. The constructing unit 41 constructs a virtual network in accordance with the system configuration definition information 31B of the specified system and constructs a virtual system obtained by combining the virtual network with the generated virtual machine.

The constructing unit 41 registers various kinds of information relating to the constructed virtual system in the management information 32. For example, the constructing unit 41 registers information on the construction destination of the system and the package used for the construction of the system in the management information 32.

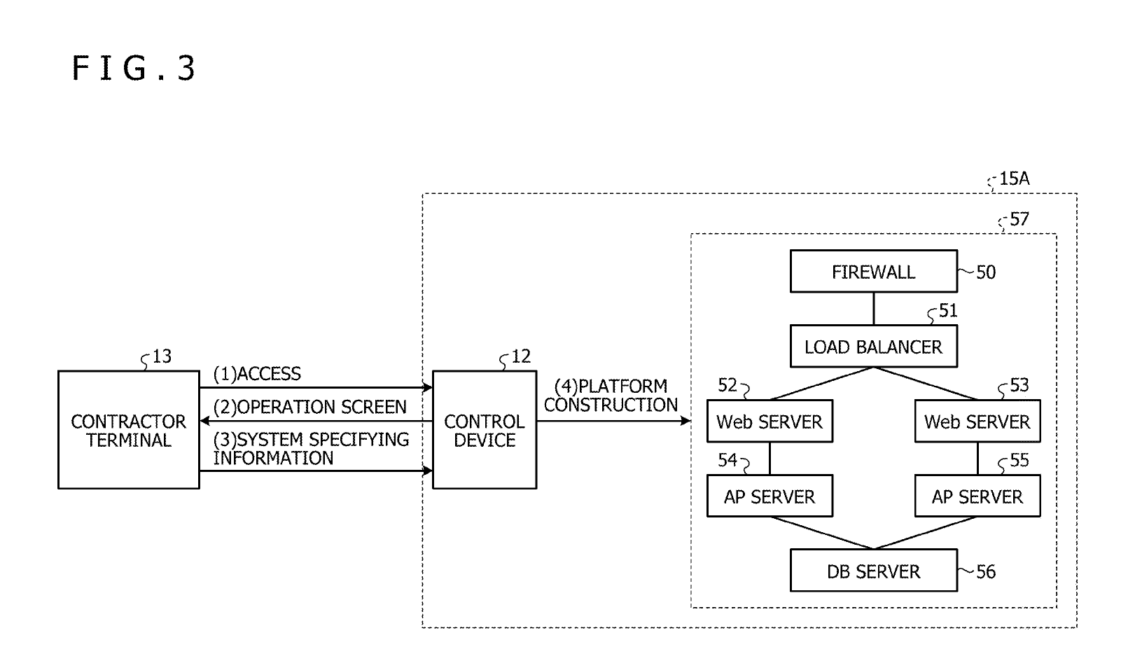

FIG. 3 is a diagram illustrating one example of flow of construction of a platform according to embodiment 1. The example of FIG. 3 represents the flow of construction of the platform in the data center 15A by a contractor of the data center 15A. When the control device 12 accepts access from the contractor terminal 13 (FIG. 3(1)), the control device 12 transmits information on an operation screen and causes the contractor terminal 13 to display the operation screen (FIG. 3(2)). Then, when the control device 12 accepts specifying of a system to be constructed as a platform (FIG. 3(3)), the control device 12 constructs the platform (FIG. 3(4)). In the example of FIG. 3, a virtual system 57 in which one firewall 50, one load balancer 51, two Web servers 52 and 53, two AP servers 54 and 55, and one DB server 56 are coupled to a network is generated as the platform. The platform illustrated in FIG. 3 is one example and the platform is not limited thereto. For the platform, the configuration of the system may be changed by changing the definition information. Furthermore, it is also possible to generate plural platforms with the same configuration or different configurations. For example, it is also possible for the contractor to generate, in the cloud 10, a platform for operation with which a business is carried out and a test platform for testing a new function.

Incidentally, the contractor constructs the same system as a system that has been constructed in a distributed manner in some cases. For example, in the case of carrying out backup or load balancing of a system that has been constructed, the contractor desires to construct the same system in the data center 15 different from the data center 15 in which the system that has been constructed runs. Furthermore, for example, the contractor constructs and operates a system of Web services such as an electronic commerce (EC) site in the data center 15 in country A and desires to construct the same system in the data center 15B in country B in the case of newly opening the same EC site also in country B.

Therefore, the accepting unit 40 accepts an instruction to construct the system in the different data center 15 from the operation screen.

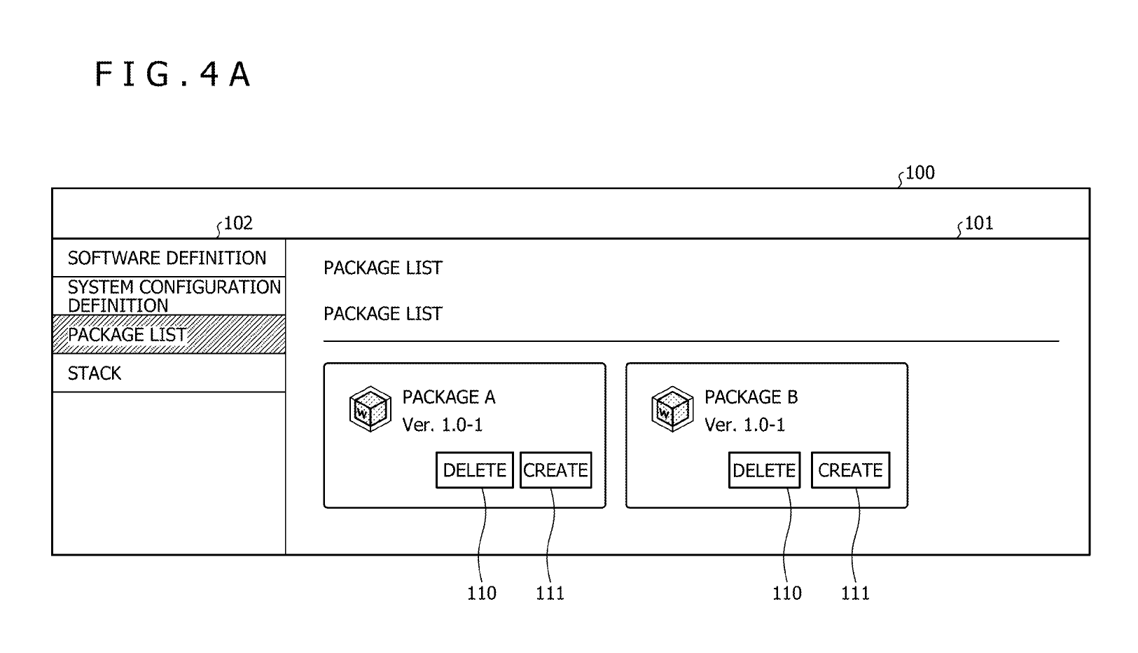

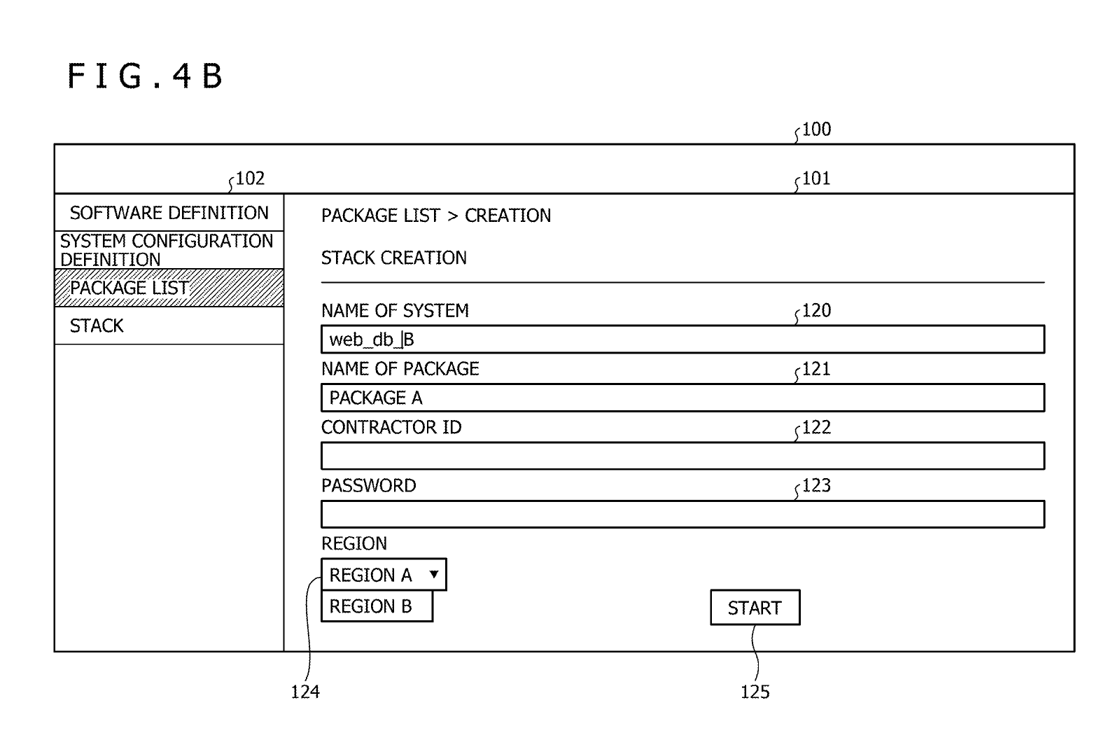

FIG. 4A is a diagram illustrating one example of an operation screen according to embodiment 1. In an operation screen 100, a main area 101 that displays various kinds of information and a menu area 102 on the left side are set. In the menu area 102, a menu to specify the display contents of the main area 101 is displayed. In the menu area 102, “software definition,” “system configuration definition,” “package list,” and “stack” are displayed to be vertically lined up as the menu.

The menu of “software definition” is a menu to make an instruction to display a screen with which software definition is registered. When the menu of “software definition” is selected, various kinds of entry areas for entering information relating to software used in a system are displayed in the main area 101. For example, the accepting unit 40 accepts specifying relating to software, such as the number of servers constructed as a system, the OS with which the servers are equipped, middleware, and applications, from the main area 101 resulting from the selection of the menu of “software definition.”

The menu of “system configuration definition” is a menu to make an instruction to display a screen with which the system configuration is registered. When the menu of “system configuration definition” is selected, various kinds of entry areas for entering information relating to the configuration of a system, such as the configuration of the network among servers used in the system, are displayed in the main area 101. For example, the accepting unit 40 accepts specifying relating to the system configuration such as the configuration of the network among the servers from the main area 101 resulting from the selection of the menu of “system configuration definition.”

The menu of “package list” is a menu to make an instruction to display a screen with which a system is constructed. When the menu of “package list” is selected, systems whose definition information used for construction of the system have been registered are displayed as packages in the main area 101.

The menu of “stack” is a menu to make an instruction to display a screen that displays the state of systems that have been constructed. When the menu of “stack” is selected, the state of systems that have been constructed is displayed in the main area 101.

The example of FIG. 4A represents the state in which “package list” is selected in the menu area 102. In the main area 101, the names of systems whose definition information used for construction of the system have been registered are displayed in a list as packages. In the example of FIG. 4A, “package A” and “package B” are displayed as the packages. Furthermore, in the main area 101, a deletion button 110 and a creation button 111 are displayed for each package. The deletion button 110 is a button to specify deletion of the definition information of the system of the package. The creation button 111 is a button to make an instruction to construct the system by using the definition information of the system of the package.

In the case of newly constructing a system, the contractor selects the creation button 111 of the package to be constructed from the operation screen 100. For example, the contractor selects the creation button 111 of “package A” in the case of newly constructing the system of “package A.”

FIG. 4B is a diagram illustrating one example of an operation screen according to embodiment 1. The example of FIG. 4B represents one example of the operation screen 100 displayed when the creation button 111 of “package A” is selected. In the main area 101, an entry area 120 into which the name of the system to be newly created is entered and a display area 121 that displays the name of the package used for construction of the system are displayed. In the example of FIG. 4B, “package A” whose creation button 111 is selected is displayed in the display area 121.

Furthermore, in the main area 101, an entry area 122 of the contractor ID of the contractor that makes an instruction of construction and an entry area 123 of the password are displayed. In the case of using the contractor ID and the password when login is carried out, the entry area 122 of the contractor ID and the entry area 123 of the password may be absent.

Moreover, in the main area 101, a selection area 124 to specify the region of the construction destination and a start button 125 to make an instruction to start construction of the system are displayed. The regions that may be selected are displayed in the selection area 124. In the example of FIG. 4B, “region A” and “region B” are displayed in the selection area 124. “Region A” is an option to specify the data center 15A existing in region A as the construction destination of the system. “Region B” is an option to specify the data center 15B existing in region B as the construction destination of the system.

The contractor enters the name of the system to be newly constructed into the entry area 120. Furthermore, the contractor enters the contractor ID into the entry area 122 and enters the password into the entry area 123. For example, in the case of newly constructing a system in the data center 15A, the contractor selects “region A” in the selection area 124 and selects the start button 125. Due to this, the system is constructed in the data center 15A as illustrated in FIG. 3, for example. Moreover, in the case of constructing, in the data center 15B, the same system as the system constructed in the data center 15A, the contractor selects “region B” in the selection area 124 and selects the start button 125.

Referring back to FIG. 2, the synchronizing unit 42 synchronizes pieces of the repository data 30 of the respective data centers 15 at given synchronization timing. For example, the synchronizing unit 42 communicates with the synchronizing unit 42 of the control device 12 of another data center 15 to synchronize pieces of the repository data 30 of the respective data centers 15. The synchronization timing may be the timing of regular processing such as date-and-time processing or may be the timing when the same system as a system that has been constructed is constructed in another data center 15. For example, when the same system as a system that has been constructed is constructed in another data center 15, the synchronizing unit 42 synchronizes the repository data 30 of the data center 15 in which the system that has been constructed runs and the repository data 30 of the other data center 15 as the construction destination. The synchronizing unit 42 may employ the repository data 30 of any data center 15 as a master and copy the repository data 30 of the master into the repository data 30 of the data center 15 other than the master to synchronize the pieces of the repository data 30. Moreover, the synchronizing unit 42 may compare pieces of software stored in pieces of the repository data 30 of the respective data centers 15 and mutually copy deficient software and software of a new version to synchronize the pieces of the repository data 30. In addition, in the case of constructing the same system as a system that has been constructed in another data center 15, the synchronizing unit 42 may cause the repository data 30 of the other data center 15 to be synchronized with the repository data 30 of the data center 15 in which the system that has been constructed runs. Furthermore, the synchronizing unit 42 of the control device 12 of each data center 15 may download the repository data 30 as the master from another server that stores the repository data 30 as the master and thereby synchronize the repository data 30 as the master with the repository data 30.

The transmitting unit 43 carries out various kinds of transmission. For example, when the same system as a system that has been constructed is constructed in another data center 15, the transmitting unit 43 transmits the definition information of the system that has been constructed, stored in the system information 31, to the control device 12 of the other data center 15. For example, in the case of constructing the system of “package A” in the data center 15B, the transmitting unit 43 reads out the software definition information 31A and the system configuration definition information 31B of the system of “package A” from the system information 31. The transmitting unit 43 transmits the read-out software definition information 31A and system configuration definition information 31B of the system of “package A” to the control device 12 of the data center 15B.

In the other data center 15, the control device 12 of the other data center 15 constructs the system based on the received definition information. For example, in the data center 15B, the constructing unit 41 of the control device 12 of the data center 15B constructs the system of “package A” in the data center 15B from the received software definition information 31A and system configuration definition information 31B of the system of “package A.”

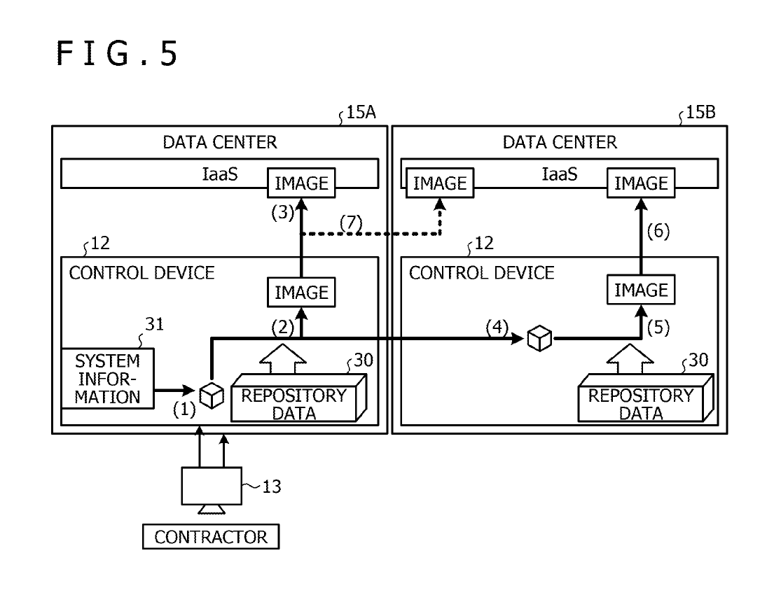

FIG. 5 is a diagram illustrating one example of construction of a system according to embodiment 1. In the example of FIG. 5, the flow of a process in which the contractor accesses the control device 12 of the data center 15A from the contractor terminal 13 and specifies a package to construct a system in the data center 15A is represented. For example, the contractor specifies the package of the system to be constructed and instructs the data center 15A to construct the system.

The control device 12 of the data center 15A reads out the definition information of the system of the specified package from the system information 31 (FIG. 5(1)). For example, the control device 12 of the data center 15A reads out the software definition information 31A and the system configuration definition information 31B of the system of the specified package from the system information 31.

The control device 12 of the data center 15A generates an image of the system based on the read-out definition information (FIG. 5(2)). For example, the control device 12 of the data center 15A reads out OS, middleware, and application software from the repository data 30 in accordance with the read-out software definition information 31A. The control device 12 of the data center 15A embeds the OS, middleware, and application software specified in the software definition information 31A and generates a virtual machine having functions according to the specified kind. The control device 12 of the data center 15A constructs a virtual network in accordance with the configuration of the network specified in the read-out system configuration definition information 31B and generates the image of a virtual system obtained by combining the virtual network with the generated virtual machine.

The control device 12 of the data center 15A develops the generated image of the virtual system into the IaaS of the data center 15A to deploy the system (FIG. 5(3)). For example, the control device 12 of the data center 15A develops the image of the virtual system into each server device 11 of the data center 15A to deploy the system.

The control device 12 of the data center 15A registers, in the management information 32, information on the package used for the construction of the system deployed in the data center 15A. Furthermore, the control device 12 of the data center 15A monitors the state of the system deployed in the data center 15A as needed and registers the state in the management information 32.

Furthermore, in the example of FIG. 5, the flow of a process in which the contractor accesses the control device 12 of the data center 15A from the contractor terminal 13 and constructs, in the data center 15B, the same system as a system that has been constructed in the data center 15A is represented. For example, the constructor specifies the same package as the system that has been constructed in the data center 15A and instructs the data center 15B to construct the system.

The control device 12 of the data center 15A reads out the definition information of the system of the specified package from the system information 31 (FIG. 5(1)). For example, the control device 12 of the data center 15A reads out the software definition information 31A and the system configuration definition information 31B of the system of the specified package from the system information 31.

The control device 12 of the data center 15A transmits the read-out definition information to the control device 12 of the data center 15B (FIG. 5(4)). For example, the control device 12 of the data center 15A transmits the read-out software definition information 31A and system configuration definition information 31B to the control device 12 of the data center 15B.

The control device 12 of the data center 15B generates an image of the system based on the received definition information (FIG. 5(5)). The control device 12 of the data center 15B develops the generated image of a virtual system into the IaaS of the data center 15B to deploy the system (FIG. 5(6)).

Here, for example, in the case of constructing, in the data center 15B, the same system as a system that has been constructed in the data center 15A, it is conceivable that an image of the system that has been constructed in the data center 15A is transferred to the data center 15B as represented by a dashed line (FIG. 5(7)). However, the image of the system has a large volume and a transfer load is imposed on the network if the image of the system is transferred.

On the other hand, the cloud 10 according to the present embodiment transmits the definition information of the system from the control device 12 of the data center 15A to the control device 12 of the data center 15B and causes the system to be constructed in the control device 12 of the data center 15B (FIGS. 5(4) to 5(6)). For example, in the case of constructing the same system as the system of the data center 15A in the data center 15B, the cloud 10 according to the present embodiment transmits the definition information of the system without transmitting the image of the system from the data center 15A to the data center 15B. The definition information of the system has a small volume compared with the image of the system. As a result, when causing the same system as the system constructed in the data center 15A to be constructed in the data center 15B, the control device 12 of the cloud 10 according to the present embodiment may construct the same system in the data center 15B with suppression of the transfer load. For example, the network N1 among the data centers 15 has a low communication speed, and it takes a longer time to transfer data when the amount of data is larger. The control device 12 may rapidly construct the system in the transfer destination by transmitting the definition information of the system without transmitting the image of the system.

The control device 12 of the data center 15B monitors the state of the constructed system as needed and notifies the state to the control device 12 of the data center 15A as needed.

The control device 12 of the data center 15A registers, in the management information 32, information on the package used for the construction of the system deployed in the data center 15B. Furthermore, the control device 12 of the data center 15A registers, in the management information 32, the state of the system deployed in the data center 15B, notified from the control device 12 of the data center 15B.

The state of the constructed system is allowed to be referenced from the operation screen 100.

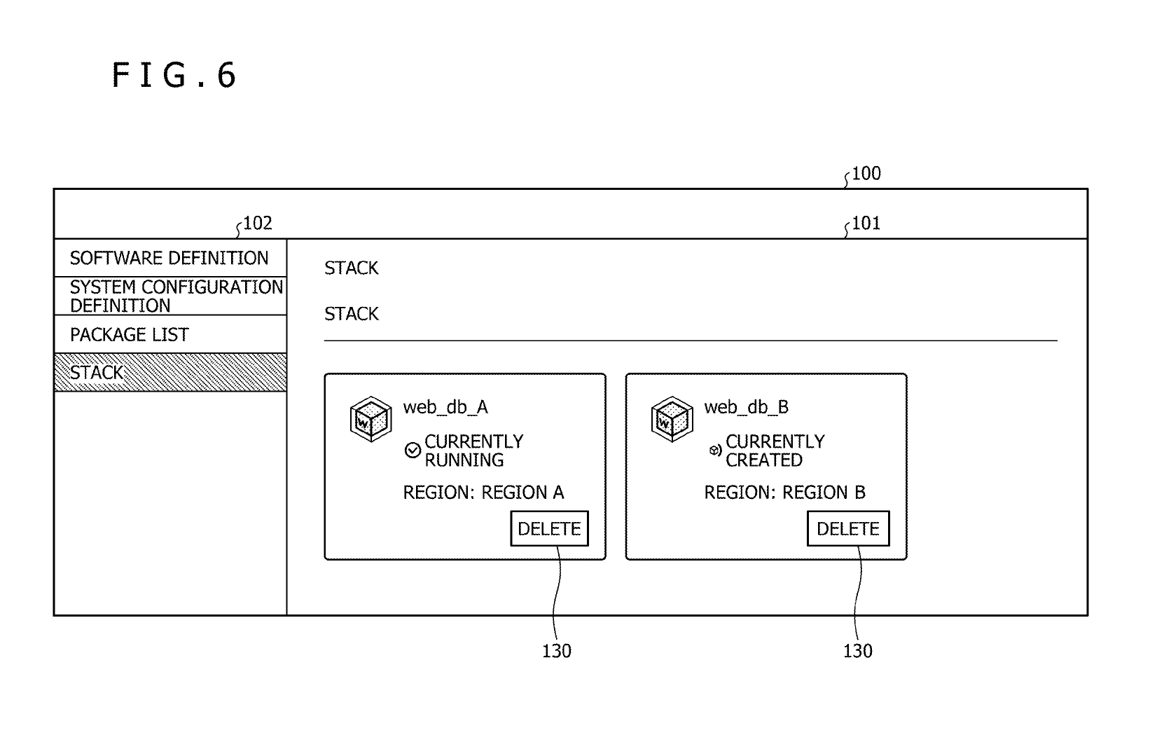

FIG. 6 is a diagram illustrating one example of an operation screen according to embodiment 1. The example of FIG. 6 represents the state in which “stack” is selected in the menu area 102. In the main area 101, the state of constructed systems is displayed. In the example of FIG. 6, it is represented that a system whose name is “web_db_A” is constructed in region A and the state of the system is the currently-running state. It is represented that a system whose name is “web_db_B” is constructed in region B and the state of the system is the currently-created state. A deletion button 130 is displayed in each of the constructed systems. When the deletion button 130 is selected, the constructed system is deleted.

<Flow of Processing>

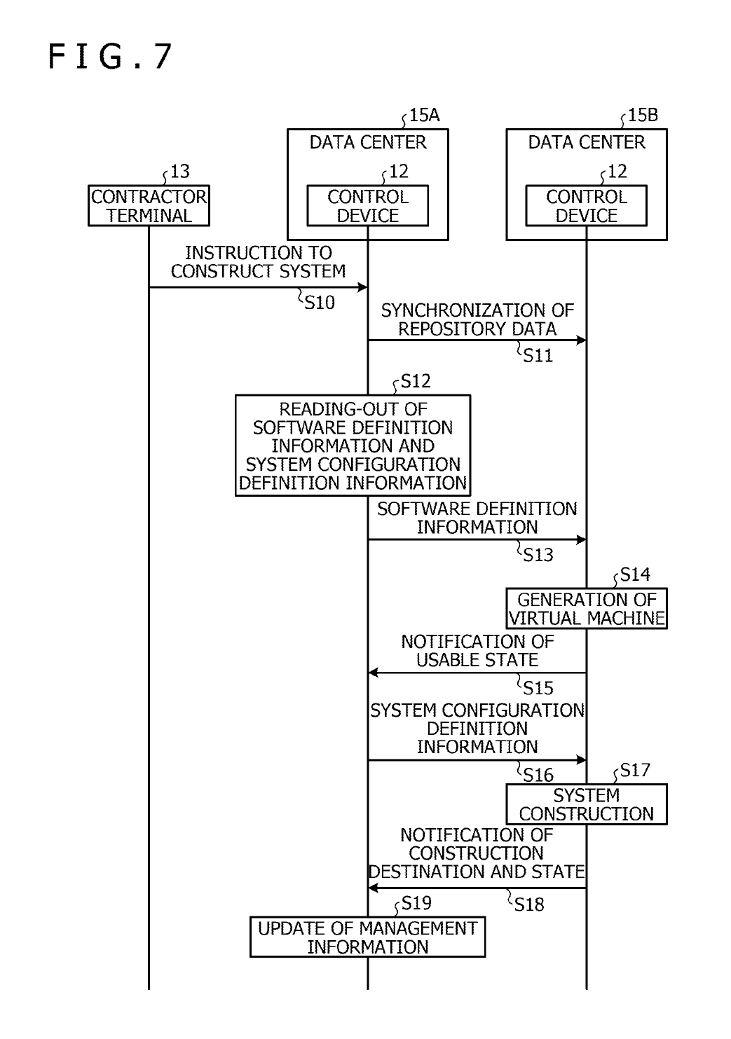

Next, the flow of the control processing when a system is constructed in a different data center 15 in the cloud 10 according to embodiment 1 will be described in detail. FIG. 7 is a diagram for explaining one example of flow of control processing according to embodiment 1. The example of FIG. 7 represents the flow of construction of a system from the data center 15A to the data center 15B.

In the control device 12 of the data center 15A, the accepting unit 40 accepts an instruction to specify a package and construct the system in the data center 15B from the contractor terminal 13 (step S10).

In the control device 12 of the data center 15A, the synchronizing unit 42 synchronizes the repository data 30 of the data center 15A and the repository data 30 of the data center 15B (step S11). For example, the synchronizing unit 42 determines whether the repository data 30 of the data center 15A and the repository data 30 of the data center 15B are identical. For example, the synchronizing unit 42 determines whether the OS used in the system of the specified package is identical between the repository data 30 of the data center 15A and the repository data 30 of the data center 15B. If the OS is not identical as the result of the determination, the synchronizing unit 42 synchronizes the repository data 30 of the data center 15A and the repository data 30 of the data center 15B.

In the control device 12 of the data center 15A, the transmitting unit 43 reads out the software definition information 31A and the system configuration definition information 31B of the system of the specified package from the system information 31 (step S12).

In the control device 12 of the data center 15A, the transmitting unit 43 transmits the read-out software definition information 31A to the control device 12 of the data center 15B (step S13).

In the control device 12 of the data center 15B, the constructing unit 41 generates an image of a virtual machine in accordance with the received software definition information 31A (step S14). For example, the constructing unit 41 reads out OS, middleware, and application software from the repository data 30 in accordance with the received software definition information 31A. Then, the constructing unit 41 generates a virtual server image and embeds the OS, middleware, and application software specified in the received software definition information 31A to generate the image of the virtual machine having functions according to the specified kind.

In the control device 12 of the data center 15B, the constructing unit 41 notifies the control device 12 of the data center 15A that the software used for the system has become the usable state (step S15). For example, in the control device 12 of the data center 15B, the constructing unit 41 notifies the control device 12 of the data center 15A that the generation of the virtual machine has been completed.

In the control device 12 of the data center 15A, when the notification indicating that the software has become the usable state is received, the transmitting unit 43 transmits the read-out system configuration definition information 31B to the control device 12 of the data center 15B (step S16).

In the control device 12 of the data center 15B, the constructing unit 41 constructs a virtual network in accordance with the received system configuration definition information 31B and deploys the virtual network with the generated image of the virtual machine to construct a virtual system obtained by combining the virtual network with the virtual machine (step S17).

In the control device 12 of the data center 15B, the constructing unit 41 notifies the control device 12 of the data center 15A of information on the construction destination and state of the constructed virtual system (step S18).

In the control device 12 of the data center 15A, the constructing unit 41 registers the notified information on the construction destination and state of the virtual system in the management information 32 and manages the information (step S19).

As above, the control device 12 according to the present embodiment accepts registration of the system configuration definition information 31B relating to system construction and the software definition information 31A relating to the software used for the system construction. The control device 12 constructs a first system in the data center 15A by using the software definition information 31A and the system configuration definition information 31B. When causing the same system as the first system to be constructed in the data center 15B, the control device 12 transmits the software definition information 31A and the system configuration definition information 31B to the control device 12 of the data center 15B. This allows the control device 12 to construct the same system in the construction destination with suppression of the transfer load.

Furthermore, when causing the control device 12 of the data center 15B to construct the system in the data center 15B, the control device 12 according to the present embodiment further executes processing of synchronizing a first OS used in the data center 15A and a second OS used in the data center 15B. This allows the control device 12 to construct the second system in the data center 15B by using the same OS as the first system of the data center 15A.

Moreover, it is assumed that, in the cloud 10 according to the present embodiment, the data center 15A and the data center 15B are clouds corresponding to regions different from each other. There is the case in which communication is carried out between the data centers 15 different in the region through an external network such as the Internet, and it is difficult to sufficiently ensure the communication speed in some cases. When the same system is constructed in another data center 15 different in the region as above, the control device 12 may suppress the volume of the transferred data and cause the same system to be rapidly constructed in the construction destination by transmitting the definition information of the system.

In addition, the control device 12 according to the present embodiment transmits the software definition information 31A to the control device 12 of the data center 15B. The control device 12 transmits the system configuration definition information 31B after the software used for the system in the data center 15B has become the usable state. This allows the control device 12 of the data center 15A to transmit the definition information used in the construction of the system to the control device 12 of the data center 15B at the timing of the use. Moreover, the control device 12 of the data center 15B may receive the definition information that is used at the timing of the use and thus the storage area for storing the definition information may be reduced.

Furthermore, the control device 12 according to the present embodiment manages the first system constructed in the data center 15A and the second system that is constructed in the data center 15B and is the same as the first system. This allows the contractor that manages the first system and the second system to manage the first system and the second system by only accessing the control device 12 of the data center 15A.

Moreover, when causing the same system as the first system to be constructed in the data center 15B, the control device 12 according to the present embodiment determines whether the first OS used in the data center 15A and the second OS used in the data center 15B are identical. If the first OS and the second OS are not identical, the control device 12 synchronizes the first OS used in the data center 15A and the second OS used in the data center 15B. The control device 12 may alleviate the load of the synchronization processing by carrying out the synchronization only when the first OS and the second OS are not identical.

### Embodiment 2

Although the embodiment of the present disclosure is described thus far, techniques of the present disclosure may be carried out in various different forms besides the above-described embodiment.

For example, in the above-described embodiment, the case is described in which, when the same system as a system that has been constructed is constructed in another data center 15, specifying of the package used for the construction of the system that has been constructed and the data center 15 of the construction destination is accepted from the operation screen. However, the configuration is not limited thereto. For example, the accepting unit 40 may accept specifying of the system that has been constructed and the data center 15 of the construction destination from the operation screen. In this case, the transmitting unit 43 refers to the management information 32 and identifies the package used for the construction of the specified system that has been constructed. Then, the transmitting unit 43 may read out the software definition information 31A and the system configuration definition information 31B of the specified package from the system information 31 and transmit the software definition information 31A and the system configuration definition information 31B to the control device 12 of the data center 15 of the construction destination.

Furthermore, in the above-described embodiment, the case is described in which the control device 12 of the data center 15A separately accepts instructions of construction in the data center 15A and the data center 15B from the operation screen regarding the same system. However, the configuration is not limited thereto. For example, the control device 12 of the data center 15A may simultaneously accept instructions of construction in the data center 15A and the data center 15B from the operation screen regarding the same system. In this case, the constructing unit 41 of the control device 12 of the data center 15A reads out the definition information relating to the system regarding which construction is specified from the system information 31, and constructs the system in the data center 15A based on the read-out definition information. Thereafter, the transmitting unit 43 of the control device 12 of the data center 15A may transmit the read-out definition information to the control device 12 of the data center 15B and cause the same system to be constructed in the data center 15B by the control device 12 of the data center 15B.

Furthermore, it is also possible to manually execute all or part of processing described as processing that is automatically executed among the respective kinds of processing described in the present embodiment. Alternatively, it is also possible to automatically execute, by a publicly-known method, all or part of processing described as processing that is manually executed. Besides, processing procedures, control procedures, concrete names, and information including various kinds of data and parameters represented in the above-described document and drawings may be arbitrarily changed unless particularly noted.

Moreover, the respective constituent elements of the respective devices that are diagrammatically represented are functionally conceptual and do not necessarily have to be configured as diagrammatically represented physically. For example, concrete forms of distribution and integration of the respective devices are not limited to the diagrammatically-represented forms. For example, all or part of the respective devices may be configured to be distributed or integrated functionally or physically in an arbitrary unit according to various kinds of loads, the status of use, and so forth. For example, a configuration in which functions of the control device 12 are implemented into plural servers in a distributed manner may be employed. Moreover, all or an arbitrary part of the respective processing functions carried out in the respective devices may be implemented by a CPU and a program analyzed and executed in this CPU or be implemented as hardware based on wired logic.

[System]

The respective embodiments relating to the system of the disclosure are described thus far. One example of the hardware configuration of the control device 12 in the respective embodiments will be described. All or an arbitrary part of various kinds of processing functions carried out in the respective devices may be carried out on a CPU (or microcomputer such as an MPU or a micro controller unit (MCU)). Moreover, it goes without saying that all or an arbitrary part of the various kinds of processing functions may be carried out on a program analyzed and executed by the CPU (or microcomputer such as an MPU or MCU) or on hardware based on wired logic. Various kinds of processing explained in the above-described respective embodiments may be implemented by executing a program prepared in advance by a computer. Therefore, in the following, one example of a computer that executes a program having similar functions to the above-described respective embodiments will be described as one example of the hardware configuration.

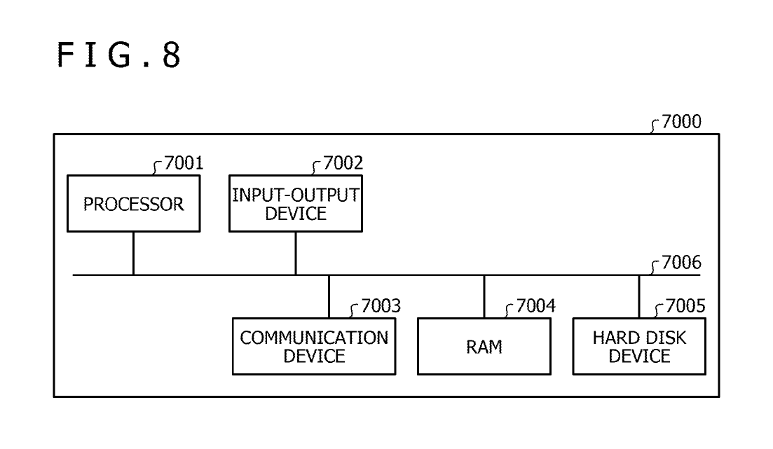

FIG. 8 is a diagram illustrating one example of a hardware configuration. The control device 12 may be implemented based on a hardware configuration similar to that of a computer 7000 illustrated in FIG. 8. As illustrated in FIG. 8, the computer 7000 includes a processor 7001 that executes various kinds of arithmetic processing, an input-output device 7002, and a communication device 7003. Furthermore, the computer 7000 includes a RAM 7004 that temporarily stores various kinds of information and a hard disk device 7005. Moreover, the respective devices 7001 to 7005 are coupled to a bus 7006.

In the hard disk device 7005, control programs having similar functions to the respective processing units of the accepting unit 40, the constructing unit 41, the synchronizing unit 42, and the transmitting unit 43 represented in the above-described respective embodiments are stored. Furthermore, the repository data 30, the system information 31, and the management information 32 are stored in the hard disk device 7005. Various kinds of data for implementing the control programs are stored in the hard disk device 7005.

The processor 7001 executes various kinds of processing by reading out the respective programs stored in the hard disk device 7005 and loading the programs into the RAM 7004 to execute the programs.

Furthermore, these programs may cause the computer 7000 to function as the accepting unit 40, the constructing unit 41, the synchronizing unit 42, and the transmitting unit 43 represented in the above-described respective embodiments. The above-described respective programs do not necessarily have to be stored in the hard disk device 7005. For example, the computer 7000 may read out and execute a program stored in a storage medium that is readable by the computer 7000.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a control program that causes a computer to execute a process for constructing a system in a cloud, the process comprising:
acquiring first definition information relating to system construction and second definition information relating to software used for the system construction;
constructing a first system in a first cloud by using the first definition information and the second definition information; and
transmitting the first definition information and the second definition information to another computer that constructs a second system in a second cloud using the first definition information and the second definition information, the second system being the same as the first system.

2. The control program according to claim 1, wherein
the control program further causes execution of processing of synchronizing a first operating system used in the first cloud and a second operating system used in the second cloud when causing the other computer to construct the second system in the second cloud, and
the processing of transmitting starts transmission of the first definition information and the second definition information after completion of the synchronizing.

3. The control program according to claim 1, wherein
the first cloud is located in a geographical region different from the second cloud.

4. The control program according to claim 1, wherein
the processing of transmitting transmits the second definition information to the other computer and transmits the first definition information to the other computer after software used for the second system in the second cloud has become a usable state, and
the control program further causes execution of processing of managing the first system and the second system.

5. The control program according to claim 2, wherein
the processing of synchronizing determines whether the first operating system used in the first cloud and the second operating system used in the second cloud are identical, and synchronizes the first operating system used in the first cloud and the second operating system used in the second cloud if the first operating system and the second operating system are not identical.

6. A control method of constructing a system in a cloud, the control method comprising:
acquiring, by a computer, first definition information relating to system construction and second definition information relating to software used for the system construction;
constructing a first system in a first cloud by using the first definition information and the second definition information; and
transmitting the first definition information and the second definition information to another computer that constructs a second system in a second cloud using the first definition information and the second definition information, the second system being the same as the first system.

7. A control device that constructs a system in a cloud, the control device comprising:
a memory; and
a processor coupled to the memory and the processor configured to
acquire first definition information relating to system construction and second definition information relating to software used for the system construction;
construct a first system in a first cloud by using the first definition information and the second definition information accepted by the accepting unit; and
transmit the first definition information and the second definition information to another control device that constructs a second system in a second cloud using the first definition information and the second definition information, the second system being the same as the first system.
